(19) United States
(12) Patent Application Publication
(10) Pub. No.: US 2010/0146582 A1
(43) Pub. Date: Jun. 10, 2010

(54) ENCRYPTION MANAGEMENT IN AN INFORMATION HANDLING SYSTEM

(75) Inventors: Muhammed Jaber, Austin, TX (US); David Konetski, Austin, TX (US); Don C. McCall, Cedar Park, TX (US); Frank H. Molsberry, Georgetown, TX (US); Kenneth Wade Stufflebeam, JR., Georgetown, TX (US); Michele A. Kopp, Georgetown, TX (US)

Correspondence Address: Baker Botts L.L.P, 910 Louisiana Street, One Shell Plaza, HOUSTON, TX, 77002, US

(73) Assignee: DELL PRODUCTS L.P., Round Rock, TX (US)

(21) Appl. No.: 12/328,213

(22) Filed: Dec. 4, 2008

(51) Int. Cl. G06F 21/00; H04L 9/06

(52) U.S. Cl. 726/1; 380/277

(57) ABSTRACT

A method of enforcing an encryption policy in an information handling system for receiving a request for access to data, automatically identifying from a plurality of encryption policies a particular encryption policy associated with the requested data, selecting an available encryption implementation module capable of enforcing the identified encryption policy, and initiating an encryption or decryption of the requested data using the selected encryption implementation module.

### TECHNICAL FIELD

The present disclosure relates generally to information handling systems and more particularly to encryption management.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, e.g., financial transaction processing, airline reservations, enterprise data storage, or global communications. In addition, information handling systems may include a variety of hardware and software components that may be configured to process, store, and communicate information and may include one or more computer systems, data storage systems, and networking systems.

Traditional encryption management is handled on an ad hoc basis. Operating systems and third-party drivers allow a user to encrypt files, folders or volumes. Some storage devices allow a user to enable encryption of all or a portion of the device. Some applications support or can be extended to support data encryption.

### SUMMARY

In accordance with the teachings of the present disclosure, disadvantages and problems associated with managing and enforcing encryption policies have been reduced.

In accordance with one embodiment of the present disclosure, a method of enforcing an encryption policy in an information handling system includes steps of receiving a request for access to data, automatically identifying from a plurality of encryption policies a particular encryption policy associated with the requested data, selecting an available encryption implementation module capable of enforcing the identified encryption policy, and initiating an encryption or decryption of the requested data using the selected encryption implementation module.

In accordance with another embodiment of the present disclosure, software embodied in tangible computer-readable media and, when executed by a processor, is operable to receive a request for access to data, automatically identify from a plurality of encryption policies a particular encryption policy associated with the requested data, select an available encryption implementation module capable of enforcing the identified encryption policy, and initiate an encryption or decryption of the requested data using the selected encryption implementation module.

In accordance with yet another embodiment of the present disclosure, an information handling system includes a processor, a memory coupled to the processor, and a security policy enforcement subsystem enabled to receive a request for access to data, automatically identify from a plurality of encryption policies a particular encryption policy associated with the requested data, select an available encryption implementation module capable of enforcing the identified encryption policy, and initiate an encryption or decryption of the requested data using the selected encryption implementation module.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an example system for managing security policies across a network, according to certain embodiments of the present disclosure;

FIG. 2 illustrates an example system for managing security policies without the use of a network, according to certain embodiments of the present disclosure;

FIG. 3 illustrates an example system for managing security policies in a single information handling system, according to certain embodiments of the present disclosure;

FIG. 4 illustrates details of components of the systems shown in FIGS. 1-3 for managing security policies, shown with additional detail, according to certain embodiments of the present disclosure;

FIG. 5 illustrates one possible data structure embodying a security policy, according to certain embodiments of the present disclosure; and

FIG. 6 illustrates an example method for enforcing an encryption policy where access to protected data has been requested, according to certain embodiments of the present disclosure.

### DETAILED DESCRIPTION

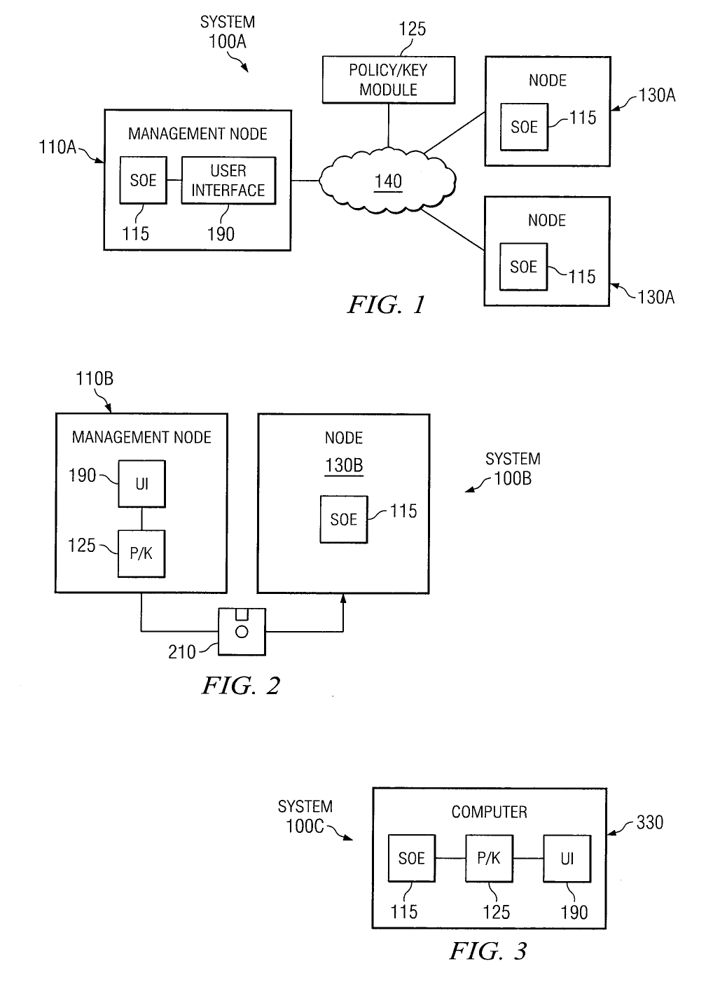

Preferred embodiments and their advantages are best understood by reference to FIGS. 1 through 6, wherein like numbers are used to indicate like and corresponding parts.

At a high level, some embodiments of the present disclosure enable a user to manage encryption policies at an abstract level without reference to specific hardware, software, and/or firmware components of an information handling system. Some embodiments enable a user to manage encryption policies across a plurality of information handling systems by creating an encryption policy once for distribution to each of the systems.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, a network router, a network video camera, a data recording device used to record physical measurements in a manufacturing environment, or any other suitable device and may vary in size, shape, performance, functionality, and price. The information handling system may include memory, one or more processing resources, e.g., a central processing unit (CPU) or hardware or software control logic. Additional components or the information handling system may include one or more storage devices, one or more communications ports for communicating with external devices as well as various input and output (I/O) devices, e.g., a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media, e.g., a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing. Computer-readable media may also include optically readable barcodes (one or two-dimensional), plastic cards with embedded magnetic stripes, mechanically or optically read punched cards, or radio frequency identification tags.

For the purposes of this disclosure, a security policy is a computer representation of at least one rule to be satisfied when a request is made for access to a computing resource. For example, a user could be required to enter a password when requesting access to a computer terminal. An encryption policy is one type of security policy addressing the encryption, decryption and/or digital signing of data. An encryption policy may be a subclass of a security policy object class or may simply be a label used to discuss a security policy that addresses the encryption or decryption of data. No specific data structure or organization is required by this disclosure. Where an encryption policy is discussed, it may be a separate and distinct data structure, or it be embodied in a more general security policy data structure.

Each computing resource to which a security policy applies (e.g., to access the computing resource) may be one or more classes of data or one or more specific data elements. A class of data may be, e.g., a file type, a physical or logical storage type (e.g., data on a laptop drive; data on removable media; data transmitted across a public network), or a category of data defined explicitly (e.g., classified or top secret data; customer data; financial data; or engineering data). This classification may be specified within the data element, may be implicit, or may be specified by an external list, rule or other mechanism.

A security policy may include one or more rules to be satisfied in the alternative; in conjunction; or by applying a more complex logical test (e.g., A and B or C but never D). In some embodiments, a security policy is a global rule requiring all data to be encrypted prior to storage. In others, multiple encryption policies specify different rules for different classes of data. For example, a security policy may specify that personal data is scrambled using a ROT13 algorithm to prevent inadvertent access, while corporate data is encrypted with one of two allowable encryption algorithms using an encryption key provided in part on a smart card or key fob and provided in part by a key server after proper authentication. Specific data may refer to a particular file, file folder, or data record, for example.

In some embodiments, a security policy may include temporal specifications to indicate when the policy should be enforced. In some embodiments a security policy may include one or more enabling or disabling trigger events, e.g., the addition or removal of a certain hardware or software resource; an idle timer; a panic mode activation; or physical movement of the information handling system. When a security policy applicable to certain data changes (through activation or deactivation), the system may be required to automatically perform some operation on that data.

Two scenarios may be instructive here. First, if a policy changes from using one form of encryption to another, a batch process may be triggered to migrate (decrypt then encrypt) any data covered by the policy. Second, if a policy can no longer be enforced on a system, any data covered by that policy may be securely deleted. For example, a newly enabled or triggered policy may require a certain form of hardware encryption and the information handling system does not have the required hardware. In another example, removal of a system from a predefined geographical area or the physical disconnection from a local area network could trigger the secure deletion of encrypted data (this is because most encryption can be defeated eventually through a brute-force attack, which may be more likely if data is physically transported to another location). In yet another example, a failure to reconnect to the corporate network within a specific window of time may prevent any access to secured data until the IHS has resonated.

In some embodiments, a key source may provide an encryption key or may provide a base for determining a key. An example of the latter is a solution to a Diffie-Hellman problem of establishing encryption keys for sharing data between two nodes (e.g., managed node 130A and policy/key module 125). The key source may provide a public key that may be used in combination with a locally stored private key to generate the encryption key used by a security operating environment (e.g., SOE 115, discussed later). In some embodiments, a key source may provide a symmetric key (which may be encapsulated for transition).

FIGS. 1-3 illustrate three example systems 100A-C for managing security policies for one or more information handling systems, according to certain embodiments of the present disclosure. In general, system 100A shown in FIG. 1 includes a management node 110A that manages security policies for one or more managed nodes 130A via a network 140. System 100B shown in FIG. 2 illustrates a management node 110B that manages security policies for one or more managed nodes 130B by transferring data using removable computer readable media. System 100C shown in FIG. 3 illustrates an information handling system 110C wherein security policies are managed internally within a single node 330. The present disclosure also covers hybrids of the three example systems 100A-C, e.g., wherein managed security policies are distributed to managed nodes via network 140 to managed nodes 130A and via removable media 210 to managed node 130B. Another hybrid might be a node 330 wherein one or more security policies are received via network 140 and/or removable media 210, but otherwise security policies are managed locally.

FIG. 1 illustrates a system 100A for managing security policies across a network. System 100A may include a management node 110A, a policy/key module 125, and one or more managed nodes 130A. Management node 110A may be communicatively coupled to managed node(s) 130A via a network 140. In some embodiments, policy/key management module 125 may be separate from management node 110A and connected to management node 110A via network 140. In other embodiments, policy/key management module 125 may be included in management node 110A. In some embodiments, multiple managed nodes 130A may be configured identically, and in other embodiments they may have different hardware, software, and/or firmware components or may be classified differently (e.g., for use only within a corporate campus versus allowed to travel in public areas).

Management node 110A generally enables a user to create, modify, delete, and/or otherwise manage security policies for distribution to managed nodes 130A, e.g., via network 140. Management node 110A may include a security operating environment (“SOE”) 115 configured to enforce security policies on management node 110A, and a user interface 190 for managing security policies for local enforcement and/or for distribution.

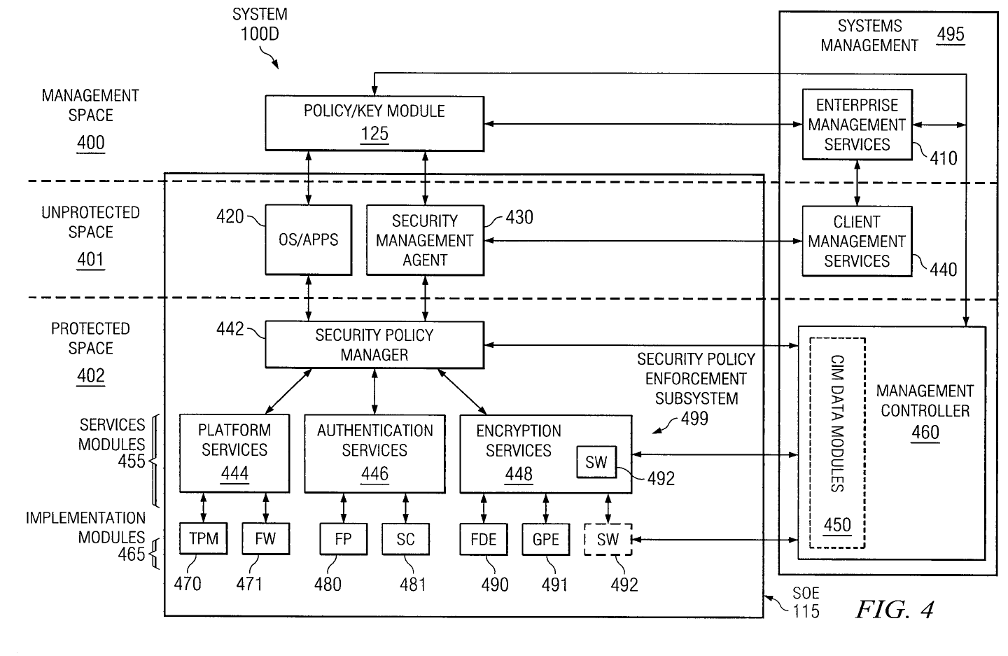

SEO 115 may include a security policy manager (“SPM”) configured to provide standardized policy enforcement and one or more services modules (e.g., services modules 455) configured to discover and/or provide access to various hardware, software and/or firmware modules that implement all or part of services requested by the SPM. These available implementation modules (e.g., implementation modules 465, discussed later) may include one or more encryption implementation modules configured to implement one or more encryption algorithms. The various components of SOE 115 are discussed in greater detail below with reference to FIG. 4.

User interface 190 is generally configured for providing one or more interfaces allowing a user to create, modify, delete, categorize, organize, and/or otherwise manage security policies (e.g., encryption policies) for managed nodes 130A. User interface 190 may comprise an implementation of the WS-Management standard (e.g., Windows Remote Management) or any other system management interface or application. In some embodiments, user interface 190 may comprise a web server or other server technology to enable a user to manage security policies remotely or locally using a standard web browser or other thin client interface. In some embodiments, user interface 190 may provide a version control system for managing security policy details. In some embodiments, user interface 190 may enable a user to manage other activation and deactivation triggers for particular security policies, e.g., an expiration date and/or time for remotely managed policies and/or local copies of encryption keys. In some embodiments, e.g., as shown and discussed below with reference to FIG. 4, user interface 190 may correspond to a generalized management system (e.g., Systems Management 495) of node 110A configured to communicate with SOE 115.

In system 100A, policy/key module 125 is generally configured to provide persistent storage of security policies for access by and/or distribution to managed nodes 130A. Policy/key module 125 may also store encryption keys for use by SOE 115 on management node 110A or managed nodes 130A. Policy/key module 125 may reside on a server, workstation, network attached storage device, or other information handling system and includes or has access to computer readable media. The persistent data could be in a database, in one or more files (e.g., in XML format) in one or more folders, and/or in a version control system.

Each managed node 130A is generally configured to perform one or more tasks that will produce and/or consume data, at least some of which is governed by a security policy. Examples of such tasks include using a word processor to create, view, modify and/or save a document on the hard drive of a managed node 130A; accessing electronic mail on a managed node 130A over network 140; and streaming digital video data from a camera to a managed node 130B. Each managed node 130A includes SOE 115 configured to enforce any relevant security policy. SOE 115 of each managed node 130A may be the same or different than SOE 115 of other managed nodes 130A. In addition, SOE 115 of a managed node 130A may be the same or different than SOE 115 of management node 100A.

In system 100A, each managed node 130A may receive security policies from policy/key module 125 via network 140. Alternatively, a managed node 130A may maintain a fixed, or updatable, library of security policies, and may receive instructions from policy/key module 125 to activate or deactivate one or more security policies from the library.

In some embodiments, managed nodes 130A in system 100A may be heterogeneous. For example, some managed nodes 130A may be thin-client systems running a light-weight operating system without any specialized hardware configured to implement security policies while other managed nodes 130A may be state-of-the-art engineering workstations incorporating a general purpose hardware encryption engine, a hard drive with full disk encryption, secure firmware and a trusted platform module. Additionally, managed node 130A may include a dedicated network attached video camera and/or a process data recording devices. Indeed, certain embodiments specifically address this heterogeneous environment by abstracting out the various hardware, software and/or firmware implementations, as well as by abstracting out the types of data to be protected to allow the specification of generalized security policies. For example, this generalization may allow for a type of rule that requires hardware encryption while SOE 115 is entrusted to discover and apply the available hardware encryption options available on managed node 130A (here, selecting between the general purpose encryption engine and the hard drive with hardware encryption).

In other embodiments, managed nodes 130A in system 100A may be homogeneous. For example, all managed nodes 130A may have substantially identical hardware, software and/or firmware capabilities as they relate to implementing security policies. Thus, system 100A may be used for managing the security of any collection of heterogeneous or homogeneous information handling systems.

Management node 110A and managed nodes 130A may comprise any type of information handling systems. For example, one or more of management node 110A and managed nodes 130A may comprise servers, personal computers, mobile computing devices (e.g., laptops or PDAs) or any other types of information handling systems.

In some embodiments of system 100A, management node 110 may be a physically secure computer system. Other embodiments may allow remote or distributed management of security policies at a management node 110 (e.g., using a laptop, handheld device, or internet browser), but may require securely authenticated and encrypted access.

Network 140 may be a network and/or fabric configured to couple management node 110A to managed nodes 130A. Network 140 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data), or any combination thereof. Network 140 may transmit data using wireless transmissions and/or wire-line transmissions via any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), advanced technology attachment (ATA), serial ATA (SATA), advanced technology attachment packet interface (ATAPI), serial storage architecture (SSA), integrated drive electronics (IDE), and/or any combination thereof. Network 140 and its various components may be implemented using hardware, software, or any combination thereof.

In operation, a user's identity may first be authenticated at managed node 190, for example by way of entry of a username and a password. The user may then access user interface 190 by launching an application or browsing to a specific web page. User interface 190 may include a graphical interface for managing security policies or may provide a text-based interface. In certain embodiments, the user uses Microsoft WS-Management to access the policy/key module 125. User interface 190 may provide various views allowing a user to search for existing security policies based on classifications of data, level of security, and/or other factors. User interface 190 may allow the user to right-click to edit an existing policy or may provide some other mechanism for doing so. In some embodiments, active security policies may only be set to expire via user interface 190 and may not be deleted or modified; this maintains a clear history and audit trail.

Within user interface 190, a user creates a new security policy by selecting a “new security policy” option from a menu, clicking on a button, typing a command, or via any other user input method. The user may then set various parameters for the security policy, e.g., a unique identifier, a record of which user created it and when, one or more requirements for platform services, one or more requirements for authentication services, one or more requirements for encryption services, a specification of associated data, a start date/time, an end date/time, a specification of another type of triggering event that would enable or disable the new policy, and/or an action to take in the event that the policy cannot be enforced (e.g., secure deletion of or denial of access to any associated data). A user may specify requirements for platform, authentication, and/or encryption services as a general requirement (e.g., a minimum level of encryption) or as a specific requirement (e.g., full disk encryption or an encryption enabled chipset). A user may categorize this new security policy or otherwise specify its relationship to other security policies. This categorization may be in addition to or in place of an objective categorization scheme keying off of fields in the policy itself, e.g., triggering event or temporal information.

User interface 190 may link to or incorporate workflow technology to require approvals by certain individuals or one or more members of an identified group of approvers. Once the new or modified security policy (“new policy”) has been approved by the entering user or by any required approvers, the new policy may be available for use by SOE 115 on managed node 130A.

If the modification was to disable or expire a policy, SOE 115 may automatically act on the policy change by migrating data previously stored under the old policy if a new policy exists, applies to the same data, and is capable of being implemented. Alternatively, the automatic action performed by SOE 115 may be to securely delete the old data or to simply block access to the old data.

FIG. 2 illustrates a system 100B for managing security policies without the use of a network, according to certain embodiments of the present disclosure. System 100B may include a management node 110B, and one or more managed nodes 130B. In some embodiments, system 100B may differ from system 100A of FIG. 1 in that management node 110B may not include SOE 115.

Management node 110B generally enables a user to create, modify, delete, and/or otherwise manage security policies for distribution to managed nodes 130B, e.g., via removable media 210. Management node 110B may include a user interface 190 for managing security policies, stored in policy/key module 125, for local enforcement and/or for distribution. Management node 110B also includes a drive, port or other interface for writing to (and possibly reading from) removable media 210.

Like managed nodes 130A of system 100A in FIG. 1, each managed node 130B of system 100B is generally configured to perform one or more tasks that will produce and/or consume data, at least some of which is governed by a security policy. Each managed node 130B includes SOE 115 configured to enforce any relevant security policy. SOE 115 of each different managed node 130B may be the same or different than SOE 115 of other managed nodes 130B. In addition, SOE 115 of a managed node 130B may be the same or different than SOE 115 of management node 110A. Managed nodes 130B also include a drive, port or other interface for reading from removable media 210. In some embodiments, write access to removable media 210 may be required if an enforcement verification record, or other audit information, must be returned to management node 110B. As with managed nodes 130A, managed nodes 130B may be any kind of information handling system and may have identical hardware configurations to any other managed nodes 130B or may have varied configurations.

In system 100B, each managed node 130B may receive security policies from policy/key module 125 via removable media 210. Alternatively, a managed node 130B may maintain a fixed, or updatable, library of security policies, and may receive instructions from removable media 210 to activate or deactivate one or more security policies from such library. In alternative embodiments, management node 110B may also interface with a network to communicate policies to a policy/key module 125 operating remote from management node 110B (configuration not shown). Furthermore, in some embodiments, a managed node 130B may be configured to access a policy/key module 125 both via a network and via removable media 210, enabling a fail over or an additional policy and key distribution system where a connection to the network is not secure or reliable. In some embodiments, management node 110B may receive security policies from removable media 210.

FIG. 3 illustrates a system 100C for managing security policies in a single information handling system node 330, according to certain embodiments of the present disclosure. System 100C may include user interface 190, SOE 115, and policy/key module 125. Policy/key module 125 may store the security policies as files (e.g., XML files) on local storage media of node 330. In some embodiments, this configuration may be employed by a user in administering her own computer in situations where personal data security is a concern, but where node 330 is not part of a network of managed collection of information handling systems. In some embodiments, user interface 190 may comprise an option on system install or may allow the user to select from one or more predefined security policy options. In some embodiments, user interface 190 may be integrated into the operating system such that the properties dialog on a folder or file offers a security policy selection interface.

In some embodiments, node 330 may also receive one or more security policy from removable media 210 or from policy/key module 125 via network 140. For example, an independent contractor may import a security policy established by his client in order to access that client's data on his own laptop. For other data, the contractor would continue to use any existing security policies.

FIG. 4 illustrates a system 100D for managing security policies, according to certain embodiments of the present disclosure. System 100D may include policy/key module 125, systems management 495, and SOE 115. In some embodiments, system 100D may correspond to any of the deployment scenarios illustrated in systems 100A, 100B, and 100C. For example, SOE 115 of system 100D may correspond to SOE 115 of system 100B in managed node 130B. As another example, systems management 495 of system 100D may correspond to systems management 495 of system 100A in management node 110A.

System 100D may be viewed as segmented into three interconnected spaces including management space 400, unprotected space 401, and protected space 402. Management space 400 may provide centralized or concentrated enterprise-wide management of policies, keys, and/or any other system information or rules. Unprotected space 401 may include operating system/applications 420 and security management agent 430, which have access to unencrypted data and may be producers and/or consumers of data to be encrypted/decrypted en route to a storage media or communications device. Protected space 402 may include various hardware, software, and/or firmware services for enforcing and implementing security policies. These services may be provided through one or more abstraction layers.

### Management Space

Management space 400 enables centralized or concentrated enterprise management of system 100D. Management space 400 may include policy/key module 125 and enterprise management services 410. Policy/key module 125 may provide centralized data storage of security policies and/or encryption keys and provide push or pull distribution of the same. Enterprise management services 410 may provide centralized management of security policies and encryption keys by one or more trusted users for persistence in and distribution by policy/key module 125.

Enterprise management services 410 generally enables trusted users to create, modify, delete, organize, enable, disable and/or expire security policies and/or encryption keys. In some embodiments, enterprise management services 410 may be an implementation of the WS-Management standard for system management or may be one of a number of proprietary management frameworks. Enterprise management services 410 may be a traditional client/server application interfacing with policy/key module 125 (and/or management controller 460), or it may be a SOAP-based thin client application framework. The interface may be text-based or graphical and may provide management functionality in the form of wizards, hierarchical editors, property sheets, and/or table views. Enterprise management services 410 may reside on one or more information handling systems, e.g., a laptop, workstation, server, PDA, thin-client terminal, and/or ASCII terminal.

### Unprotected Space

Unprotected space 401 generally enables the production, consumption and/or manipulation of protected data in an unencrypted form. Unprotected space 401 may include operating system/applications 420 and/or security management agent 430, either or both of which may be part of SOE 115 and therefore operate on management node 110A or managed node 130A of system 100A; managed node 130B of system 110B; or node 330 of system 100C. Unprotected space 401 may also include client management services 440, which may reside on the same node as SOE 115 or on a dedicated management node. Client management services 440 may reside on the same information handling system as enterprise management services 410.

Operating system/applications 420 generally enables a user to access, view, create, manipulate, organize, and/or delete data associated with one or more security policies. Operating system/applications 420 may include Microsoft Windows, Linux, or any other operating system and may include an office applications suite, graphics editing software, database applications, electronic mail applications, web browsers, or any other application accessed by an end-user of an information handling system. Operating system/applications 420 may also include autonomous software, e.g., video recording software, audio broadcast or multicast encoders and/or decoders, environmental data collection and processing applications and on-line control systems. These software modules may be aware of protected space 402 and security policies and implementation, or may be unaware and rely on some other software module to interact with protected space 402.

### Protected Space

Protected space 402 generally facilitates the implementation of the security policies through one or more abstraction layers. Protected space 402 may include security policy manager 442, one or more services modules 455, common information model (“CIM”) data models 450, management controller 460, and/or implementation modules 465. Security policy enforcement subsystem 499 generally describes one or more modules in the protected space 402 portion of SOE 115. In some embodiments, protected space 402 provides an application programming interface (“API”) to unprotected space 401 allowing the computing resources and services in unprotected space 401 to perform such tasks as encryption, decryption, digital signing, encryption key storage/access, and/or authentication. In some embodiments, this API allows access to a specific software, hardware and/or firmware implementation module 465. In some embodiments, the API provides a complete abstraction precluding any need for awareness by unprotected space 401 of details relating to the implementation of a requested service or resource.

The one or more services modules 455 may include platform services 444, authentication services 446, and/or encryption services 448, each of which is generally enabled to discover available implementation modules 465 and to connect implementation modules 465 to security policy manager 442 with or without an intervening abstraction interface. Each service module 455 may be implemented with middleware, dynamic linking, or any other appropriate software, hardware and/or firmware technology. In some embodiments, a service module may initiate a discovery routine to look for all available hardware, software and/or firmware components capable of implementing one or more of a specific set of services. This discovery may be based on a common naming scheme, an industry standard model number coding scheme, an updatable list of candidates to search for, or any other discovery mechanism. In some embodiments, a record or object may be created for each implementation module 465 indicating the properties of and/or services performed by that module.

Platform services 444 are generally enabled to provide secure key storage and access within an information handling system. Platform services 444 may include trusted platform module 470 and/or secure firmware 471. Trusted platform module 470 may be a hardware subsystem for storing one or more encryption keys inaccessible by the operating system and any applications. One of these encryption keys may be communicated across the system bus to a specific hardware-based encryption implementation module (e.g., general purpose encryption engine 491, discussed more fully later). Secure firmware 471 may provide similar key protection using firmware rather than a dedicated hardware module. In some embodiments, the key is never transmitted in clear text, but is encapsulated using asymmetric (or public-key) cryptography whenever the key is transmitted in the system. For example, when a corporate standard key is retrieved from policy/key module 125 for storage in trusted platform module 470, that corporate key is first encrypted by policy/key module 125 using the public key of trusted platform module 470. When the corporate key arrives at trusted platform module 470, it is stored in hardware inaccessible by the operating system or applications. When that corporate key is needed by an encryption implementation module (e.g., general purpose encryption 491, discussed more fully later), trusted platform module 470 may decrypt the corporate key using the module's private key and encrypt the corporate key using the general purpose encryption module 491's public key. Finally, general purpose encryption module 491 uses its own private key to decrypt the corporate key and use it to encrypt or decrypt data as requested.

Authentication services 446 are generally enabled to provide trustworthy authentication of a user or system using inputs other than a memorized pass code or phrase. Authentication services 446 may include fingerprint reader 480, smartcard reader 481, other biometric sensors and/or secure token generators. User authentication schemes typically rely on what a user knows (e.g., a password), what a user has (e.g., smartcard 481), and/or what a user “is” (e.g., biometric sensors, fingerprint reader 480 or a retinal scanner). In some embodiments, a combination of two or more of these elements is used to provide resistance against certain security risks.

Encryption services 448 are generally enabled to encrypt, decrypt and/or digitally sign data. Encryption services may include full disk encryption 490, general purpose encryption 491, and/or software encryption 492. In some embodiments, encryption services 448 accepts a request comprising an encryption algorithm, required key strength, an optional requirement that implementation module 465 implement the algorithm on specialized hardware, an encryption key, and/or an encryption key source.

Encryption services 448 may also determine the performance characteristics in order to compare and/or rank available encryption implementation modules 465 on efficiency, security, or other criteria. In terms of efficiency, encryption implementation modules 465 might be ranked by overall throughput (e.g. bytes encrypted per second) or latency (e.g. time to encrypt the first byte or time to encrypt a specified block of data) in implementing various encryption algorithms. Efficiency may also be determined as a function of power consumed per byte of data encrypted or decrypted. Encryption services 448 may then use this comparative analysis and/or ranking to determine which implementation encryption module 465 should be used to implement an encryption request.

Full disk encryption 490 is generally enabled to provide hardware encryption of data as it is written to a disk thus protecting data from unauthorized access even if the disk is physically removed from the information handling system and connected to another system. Full disk encryption 490 generally operates to encrypt all data stored using a specified encryption key.

General purpose encryption 491 is generally enabled to provide hardware-based cryptographic services for use by any application, process and/or operating system. General purpose encryption 491 may be integrated with trusted platform module 470 in a chipset or single chip, or may be provided as an external module. More than one general purpose encryption 491 implementation module may exist within or directly interfaced with a given information handling system. General purpose encryption 491 may allow the selection of an algorithm, key strength, key source, data source, and/or destination.

Software encryption 492 is generally enabled to provide software encryption using one or more encryption algorithm for use by any application, process and/or operating system. Software encryption 492 may be integrated with encryption services 448 or supplied as one or more additional software modules. In some embodiments, software encryption 492 is a fall-back implementation to be used when allowed by a given security policy, but only when a hardware implementation is not available. In some embodiments, software encryption module 492 is completely disabled. In some embodiments, software encryption module 492 provides a base level of data protection for information handling systems that do not have any hardware-based encryption support.

CIM data models 450 are generally defined to provide targeted, or lower-level management of components in an information handling system. CIM is an example of an industry standard way to define management objects, but one of skill in the art would appreciate that other approaches could be substituted. These models may be used to configure and/or manage the configurations of security policy manager 442, services modules 455, and/or implementation modules 465. In some embodiments, CIM data models 450 specify the possible and/or allowable implementation modules 465 using a protocol, e.g., SNMP. In some embodiments, CIM data models 450 may establish security policies outright, especially for embedded or autonomous information handling systems, e.g., process data collection systems or remote video capture devices. CIM data models 450 may also be used to query the system in order to discover available services modules 455 and/or implementation modules 465 and the capabilities of each.

Management controller 460 is generally enabled to process CIM data models 450 that are managed in a centralized or concentrated fashion. In some embodiments, management controller 460 may be an implementation of one or more components of a standard web-based enterprise management (WBEM), e.g., CIM-XML, CIM operations over HTTP or WS-Management.

### Operation

The following section illustrates the operation of some embodiments of the present disclosure.

In some embodiments, a word processing application (“word processor”) (illustrated as operating system/applications 420 in system 100D) may operate with awareness of protected space 402. When a user creates and saves a new file, the word processor may prompt the user to specify an encryption level, a key source, and/or a set of users with permission to access the file. In some embodiments, an “aware” word processing application may allow a user to classify the file (e.g., client information or engineering information) when saving it.

In some embodiments, an aware word processing application may attempt to open an encrypted file. The word processing application may contact SPM 442 to identify an associated security policy (from a local cache or database of such policies or directly from policy/key module 125) and implement that policy. First, the word processing application may prompt the user for an encryption key, request a key from policy/key module 125, and/or request a key from SPM 442 (which, in turn, would request that key from platform services 444). Next, the word processing application request an encryption implementation module 465 (via SPM 442) capable of performing the appropriate decryption in the requisite way and initiate decryption of the file using the key and the encryption implementation module.

In some embodiments, an unaware application may attempt to save a new file at the request of a user. The application calls a standard operating system routine that prompts a user for a file name and location. The operating system may incorporate or may have been extended to request additional information about the file including the type of data (e.g., personal, client-related, or level of security). In some embodiments, no additional information is required for implementing security policies. In some embodiments, this additional information is only requested if relevant to at least one active security policy.

In some embodiments, managed node 130A may operate autonomously. In these embodiments, SOE 115 may be configured to automatically associate any newly generated data with a valid security policy and then to implement that security policy.

In some embodiments, the data classification is stored inline with the data (e.g., as a clear-text or binary record comprising the leading or trailing bytes of an encrypted file that may or may not be stripped out during the decryption process) or within the existing metadata fields (e.g., file system properties and/or metadata). In other embodiments, the data classification is stored in one or more external data files or databases. In some embodiments, all encrypted data is stored in a virtual file system enabling all of the policy enforcement functions to be hidden within a single device driver and completely transparent to operating system/applications 420.

Security management agent 430 generally manages automated processes required by some embodiments to perform security audits, to implement certain security policies or to implement changes in security policies. Security management agent 430 is some combination of software, hardware and/or firmware configured to automatically determine what tasks are required as a result of a security policy change (e.g., new policy, newly enabled/disabled policy) or as a result of a configuration change within the information handling system. In some embodiments, security management agent 430 may perform data migration from a form complying with an old policy (or from no policy) to a form complying with a new policy. This migration would decrypt any instance of existing data associated with the old policy and encrypt using the new policy. This migration may be automatic or it may prompt a user to determine the best time and/or course of action (e.g., migrate, securely delete, archive to a remote data server before securely deleting). In some embodiments, the addition, removal or modification of any component of SOE 115 may trigger an automated process of security management agent 430. For example, multiple security policies may be associated with a given instance of data, each policy being ranked in some manner. If a new component of SOE 115 becomes available (e.g., full disk encryption), then data stored under a less preferred policy may be migrated to comply with the newly enabled, more preferred policy. Where security management agent 430 determines that an instance of data no longer satisfies any active security policies, a default policy may require secure deletion of that data and may require an audit log or archival of a copy of that data to a remote data storage server. In some embodiments, secure deletion is implemented using hardware, software and/or firmware to ensure that no decipherable data remains on the system.

Client management services 440 generally enables centralized or concentrated management of operating system/applications 420 and security management agent 430. Client management services 440 may comprise one or more management applications or configuration utilities configured to manage the available features of operating system/application 420 and security management agent 430. In some embodiments, client management services 440 may trigger the installation of application or operating system extensions to make operating system/application 420 aware of services offered by protected space 402. In some embodiments, client management services 440 may trigger the installation of security management agent 430, or configure the behavior of the same. In some embodiments, client management services 440 may configure security management agent 430 to perform audits and may aggregate and analyze the resulting audit logs.

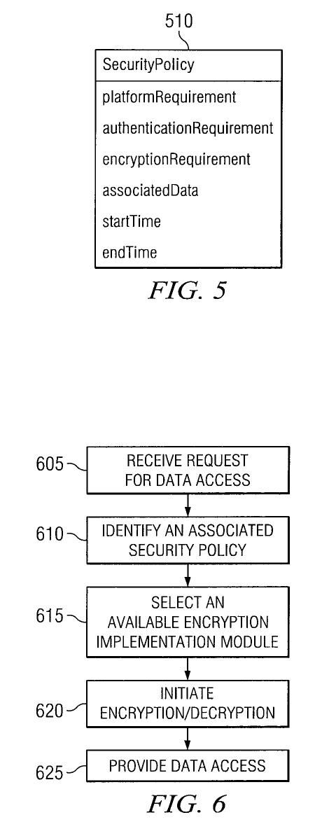

FIG. 5 illustrates one possible data structure embodying security policy 510 according to certain embodiments of the present disclosure. The platformRequirement property is a specification, or link to a specification, of one or more platform requirements, e.g., trusted platform module 470. The authenticationRequirement property is a specification, or link to a specification, of one or more authentication requirements, e.g., the use of fingerprint reader 480. The encryptionRequirement property is a specification, or link to a specification, of one or more acceptable encryption requirements, e.g., a specific algorithm, key source, implementation module 465 and/or a general requirement of hardware based encryption. The associatedData property is a specification, or link to a specification, of one or more specific data elements or classes of data. The startTime and endTime properties specify a date and, optionally, a specific time on that date when the security policy is in force. If the startTime property is left unset, the policy may be immediately in force. If the endTime property is left unset, the policy may be in force indefinitely.

FIG. 6 illustrates an example method of a system (e.g., any of systems 100A-D) enforcing an encryption policy where access to protected data has been requested, according to certain embodiments of the present disclosure. At step 605, software running in unprotected space 401 requests access to data. This software may be an operating system/application 420 or security management agent 430. The request is routed to security policy manager 442 based on application or operating system awareness of SOE 115. At step 610, security policy manager 442 identifies zero or more security policies associated with the requested data. (If no security policy exists, direct data access is allowed. In some embodiments, a default security policy is invoked in all cases.) If multiple security policies are associated with the requested data, one is selected under predetermined criteria, e.g., most efficient, most secure, most recent policy, and most specific data classification criteria.

At step 615, encryption services 448 identifies all available encryption implementation modules 465 that satisfy the encryption requirement of the identified security policy. In some embodiments, the most secure or most efficient of the satisfactory encryption implementation modules 465 is selected for use. (If no available encryption implementation module 465 is present, data access may be denied.) The selected implementation module 465 is made available to security policy manager 442 (directly, or via some abstraction layer as part of encryption services 448).

At step 620, security policy manager 442 acquires a key from the key source identified in the applicable security policy, selects an encryption algorithm if implementation module 465 provides implementation of multiple algorithms, and initializes encryption implementation module 465 for use. At step 625, security policy manager 442 provides read and/or write access to the requested data via encryption implementation module 465.

Although the disclosed embodiments have been described in detail, it should be understood that various changes, substitutions and alterations can be made to the embodiments without departing from their spirit and scope.

What is claimed is:

1. A method of enforcing an encryption policy in an information handling system comprising steps of:
receiving a request for access to data;
automatically identifying from a plurality of encryption policies a particular encryption policy associated with the requested data;
selecting an available encryption implementation module capable of enforcing the identified encryption policy; and
initiating an encryption or decryption of the requested data using the selected encryption implementation module.

2. The method of claim 1 wherein selecting an available encryption implementation module comprises:
determining a performance characteristic of each of multiple available encryption implementation modules capable of enforcing the identified encryption policy; and
selecting an encryption implementation module based at least on a comparison of the determined performance characteristics.

3. The method of claim 1 wherein the encryption policy specifies an encryption algorithm and key source, the method further comprising:
accessing an encryption key from the key source specified by the policy for use by the selected encryption implementation module.

4. The method of claim 3 wherein the key source is located remote from the information handling system.

5. The method of claim 1 wherein:
each encryption policy specifies an encryption algorithm; and
the encryption algorithm specified by a first encryption policy is different from the encryption algorithm specified by a second encryption policy.

6. The method of claim 1 wherein the key source specified in a first encryption policy is different from the key source specified in a second encryption policy.

7. The method of claim 1 further comprising:
providing a user interface for setting one of the plurality of encryption policies by a user on a second information handling system; and
communicating this set encryption policy to the first information handling system.

8. Software embodied in tangible computer-readable media and, when executed by a processor, operable to:
receive a request for access to data;
automatically identify from a plurality of encryption policies a particular encryption policy associated with the requested data;
select an available encryption implementation module capable of enforcing the identified encryption policy; and
initiate an encryption or decryption of the requested data using the selected encryption implementation module.

9. The software of claim 8 wherein:
each of a plurality of encryption implementation modules provides a data interface; and
an abstraction layer provides a standardized interface to receive the request and initiate the encryption or decryption of the requested data independent of the data interface provided by the selected encryption implementation module.

10. The software of claim 8 wherein the encryption policy specifies an encryption algorithm and key source, the method further comprising:
accessing an encryption key from the key source specified by the policy for use by the selected encryption implementation module.

11. The software of claim 10 wherein the key source is located remote from the information handling system.

12. The software of claim 8 wherein:
each encryption policy specifies an encryption algorithm; and
the encryption algorithm specified by a first encryption policy is different from the encryption algorithm specified by a second encryption policy.

13. The software of claim 8 wherein the key source specified in a first encryption policy is different from the key source specified in a second encryption policy.

14. The software of claim 8 further operable to:
provide a user interface for setting one of the plurality of encryption policies by a user on a second information handling system; and
communicate this set encryption policy to the first information handling system.

15. An information handling system comprising:
a processor;
a memory coupled to the processor; and
a security policy enforcement subsystem enabled to:
receive a request for access to data;
automatically identify from a plurality of encryption policies a particular encryption policy associated with the requested data;
select an available encryption implementation module capable of enforcing the identified encryption policy; and
initiate an encryption or decryption of the requested data using the selected encryption implementation module.

16. The information handling system of claim 15 wherein the security policy enforcement system comprises:
a security policy manager; and
an encryption services module configured to provide services to the security policy manager and to discover and request services of the encryption implementation module.

17. The information handling system of claim 15 wherein the encryption policy specifies that the encryption implementation module utilize encryption specific hardware that protects the encryption key from unauthorized access.

18. The information handling system of claim 15 wherein the encryption policy specifies an encryption algorithm and key source, the security policy enforcement subsystem further enabled to:
access an encryption key from the key source specified by the policy for use by the selected encryption implementation module.

19. The information handling system of claim 18 wherein the key source is located remote from the information handling system.

20. The information handling system of claim 15 wherein:
each encryption policy specifies an encryption algorithm; and
the encryption algorithm specified by a first encryption policy is different from the encryption algorithm specified by a second encryption policy.
